(19) United States
(12) Patent Application Publication
(10) Pub. No.: US 2012/0120326 A1
(43) Pub. Date: May 17, 2012

(54) EDGE-LIGHT ILLUMINATING DEVICE, LIQUID CRYSTAL DISPLAY DEVICE AND TELEVISION RECEIVING DEVICE

(75) Inventor: Yoshiki Takata, Osaka-shi (JP)

(73) Assignee: SHARP KABUSHIKI KAISHA, Osaka-shi, Osaka (JP)

(21) Appl. No.: 13/387,549

(22) PCT Filed: Mar. 31, 2010
(86) PCT No.: PCT/JP2010/055864

§ 371 Date: Jan. 27, 2012

(30) Foreign Application Priority Data
Jul. 30, 2009 (JP) 2009-177560

(51) Int. Cl. H04N 3/14; G02F 1/13357; G09F 13/18

(52) U.S. Cl. 348/790; 362/602; 349/65; 348/E05.133

(57) ABSTRACT

Provided is an edge-light illuminating device capable of preventing formation of a gap between point light sources and edge faces of a light guide plate, and also capable of allowing heat expansion of the light guide plate. An edge-light illuminating device 1 for illuminating a liquid crystal panel from behind includes a rectangular-shaped light guide plate 2, a wall 3 surrounding the light guide plate, a plurality of holding members 4 disposed between edge faces 7 of the light guide plate and the wall and arranged to hold the light guide plate within the wall, and two rows 6 each consisting of point light sources 5 aligned along the edge faces 7a, 7b on two adjacent sides of the light guide plate, wherein some of the holding members, which are opposed to the point light sources while interposing the light guide plate therebetween, are elastic holding members 4a having elasticity.

### TECHNICAL FIELD

The present invention relates to an edge-light illuminating device, a liquid crystal display device and a television receiving device, and specifically relates to an edge-light illuminating device including a light source consisting of a point light source such as a light-emitting diode, a liquid crystal display device including the edge-light illuminating device, and a television receiving device including the liquid crystal display device.

### BACKGROUND ART

A transmissive liquid display device, which includes a liquid crystal panel on which images and text information are to be displayed, includes an illuminating device for illuminating the liquid crystal panel from the back side of the panel (i.e., a backlight). An edge-light illuminating device is well known as this kind of illuminating device, which includes a plate-shaped light guide plate made from a transparent material such as an acrylic resin, and a light source such as a cold cathode fluorescent tube and a light-emitting diode that is disposed along an edge face of the light guide plate. Because a thin profile of the edge-light illuminating device having this configuration can be advantageously achieved more easily than other illuminating devices, the edge-light illuminating device has been used favorably in recent years.

In particular, an illuminating device including a light-emitting diode as alight source has the advantages of a long life and a high luminous efficiency, which has been receiving widespread attention. Examples of an edge-light illuminating device including a light-emitting diode as a light source include edge-light illuminating devices disclosed in PTL 1. Disclosed in PTL 1 is an edge-light illuminating device including a plurality of light-emitting diodes that are disposed along only one side of a rectangular-shaped light guide plate, and an edge-light illuminating device including light-emitting diodes that are disposed along adjacent two sides of a rectangular-shaped light guide plate.

In recent years, oversize liquid crystal display devices have been growing in demand. Each oversize liquid crystal display device includes light-emitting diodes that are disposed along adjacent two sides of a rectangular-shaped light guide plate in order to increase the light amount because if each oversize liquid crystal display device includes light-emitting diodes that are disposed along only one side of a rectangular-shaped light guide plate, they could sometimes cause a shortage of the light amount.

### CITATION LIST

### Patent Literature

PTL 1: JP2006-235436

### SUMMARY OF INVENTION

### Technical Problem

Reduction of a gap between a light source and an edge face of a light guide plate, or preferably closure of the gap is required of an edge-light illuminating device. This is because when the gap is smaller, light from the light source can be made to efficiently enter the light guide plate from the edge face of the light guide plate, while when the gap is larger, the efficiency of the incident light from the light source reduces because the light is reflected on the edge face of the light guide plate. For example, the efficiency of the incident light could differ by 10% between a case where a gap of 1 mm exists between the light source (light-emitting diode) and the edge face of the light guide plate and a case where no gap exists between them (i.e., a case where the gap is 0 mm).

In particular, an edge-light illuminating device including a point light source such as a light-emitting diode is desired to use light from the light source without wasting in comparison with an edge-light illuminating device including a line light source such as a cold cathode fluorescent tube.

The light guide plate could be expanded by heat generated by the light source. The light guide plate expanded by heat could excessively press to break the light source such as a light-emitting diode. Taking the heat expansion of the light guide plate into consideration, it is preferable to open up the gap between the light source and the edge face of the light guide plate to some extent. However, if the gap is larger, a problem arises because the efficiency of the incident light significantly reduces.

While the light-emitting diode used as the light source has the advantages of a long life and a high luminous efficiency, it has a problem of emitting a strong electromagnetic wave compared with a cold cathode fluorescent tube. For example, the light source consisting of the cold cathode fluorescent tube operates at low currents such as 4 mA to 10 mA. In contrast, the light source consisting of the light-emitting diode operates at high currents such as 20 mA to 500 mA. Thus, in using the light-emitting diode as the light source, the electromagnetic wave emitted from the light source can cause interference with integrated circuits placed around the light source, which has an adverse effect on them.

An object of the present invention is to provide an edge-light illuminating device that includes a light guide plate having a rectangular shape, and a plurality of point light sources disposed along edge faces on two adjacent sides of the light guide plate, the edge-light illuminating device being capable of preventing formation of a gap between the point light sources and the edge faces of the light guide plate, and is also capable of allowing heat expansion of the light guide plate.

Other objects of the present invention are to provide a liquid crystal display device including the edge-light illuminating device, and a television receiving device including the liquid crystal display device.

### Solution to Problem

<1> An edge-light illuminating device for illuminating a liquid crystal panel from a back side of the panel including a light guide plate having a rectangular shape, a wall that surrounds the light guide plate, a plurality of holding members that are disposed between edge faces of the light guide plate and the wall and arranged to hold the light guide plate within the wall, and two rows each consisting of a plurality of point light sources, the two rows each being aligned along the edge faces on two adjacent sides of the light guide plate, wherein some of the holding members, which are opposed to the point light sources while interposing the light guide plate therebetween, define elastic holding members having elasticity.

<2> The edge-light illuminating device according to <1>, wherein the elastic holding members are made from an elastic material, and each define convex members projecting from the wall.

<3> The edge-light illuminating device according to <1>, wherein the elastic holding members each define plate springs that extend from the wall, and the plate springs each include tips that are bent and droop down.

<4> The edge-light illuminating device according to any one of <1> to <3>, wherein the elastic holding members are made from a white-colored material.

<5> The edge-light illuminating device according to any one of <1> to <4>, wherein the light guide plate includes a plurality of scattering members distributed on a back face of the light guide plate, the scattering members being arranged to scatter light that enters from the edge faces and emit the light from a front face of the light guide plate, wherein the scattering members are distributed in a manner that the scattering members gradually concentrate from the sides along which the point light source rows are disposed toward the sides along which the elastic holding members are disposed.

<6> The edge-light illuminating device according to any one of <1> to <5>, wherein the point light sources define light-emitting diodes.

<7> The edge-light illuminating device according to any one of <1> to <6>, wherein the wall is made from a white-colored material, and the holding members are made from a transparent material.

<8> The edge-light illuminating device according to any one of <1> to <7>, wherein the holding members define members, each of which has a rectangular shape in cross section and includes a touch face that is in touch with one of the edge faces of the light guide plate, a top face, and an edge portion between the touch face and the top face, the edge portion being chamfered.

<9> A liquid crystal display device including a liquid crystal panel, and the edge-light illuminating device according to any one of <1> to <8>.

<10> The liquid crystal display device according to <9>, wherein the liquid crystal panel includes drivers disposed at positions corresponding to two adjacent sides of the light guide plate, the two adjacent sides being other than the sides of the light guide plate along which the rows of the point light sources are aligned, the drivers being arranged to provide driving signals to the liquid crystal panel.

<11> A television receiving device that includes the liquid crystal display device according to <9> or <10>.

<12> An edge-light illuminating device for illuminating a liquid crystal panel from a back side of the panel, the panel being used in a standing position, including a light guide plate having a rectangular shape, a wall that surrounds the light guide plate, a plurality of holding members that are disposed between edge faces of the light guide plate and the wall, and arranged to hold the light guide plate within the wall, and a light source aligned along one of the edge faces of the light guide plate, wherein the holding members are disposed between the edge faces except the upper edge face and the wall.

<13> The edge-light illuminating device according to <12>, wherein the elastic holding members are made from an elastic material, and each define convex members projecting from the wall.

<14> The edge-light illuminating device according to <12>, wherein the elastic holding members each define plate springs that extend from the wall, and the plate springs each include tips that are bent and droop down.

<15> The edge-light illuminating device according to any one of <12> to <14>, wherein the elastic holding members are made from a white-colored material.

<16> The edge-light illuminating device according to any one of <12> to <15>, wherein the light guide plate includes a plurality of scattering members distributed on a back face of the light guide plate, the scattering members being arranged to scatter light that enters from the edge faces and emit the light from a front face of the light guide plate, wherein the scattering members are distributed in a manner that the scattering members gradually concentrate from the sides along which the point light source rows are disposed toward the sides along which the elastic holding members are disposed.

<17> The edge-light illuminating device according to any one of <12> to <16>, wherein the point light sources define light-emitting diodes.

<18> The edge-light illuminating device according to any one of <12> to <17>, wherein the wall is made from a white-colored material, and the holding members are made from a transparent material.

<19> The edge-light illuminating device according to any one of <12> to <18>, wherein the holding members define members, each of which has a rectangular shape in cross section and includes a touch face that is in touch with one of the edge faces of the light guide plate, a top face, and an edge portion between the touch face and the top face, the edge portion being chamfered.

<20> The edge-light illuminating device according to any one of <12> to <19>, wherein the light source defines a light-emitting diode.

<21> A liquid crystal display device including a liquid crystal panel, and the edge-light illuminating device according to any one of <12> to <20>.

<22> A television receiving device that includes the liquid crystal display device according to <21>.

### Advantageous Effects of Invention

According to the preferred embodiments of the present invention, having the configuration that the plurality of point light sources are disposed along each of the edge faces on the two adjacent sides of the rectangular-shaped light guide plate, the edge-light illuminating device is capable of preventing formation of a gap between the point light sources and the edge faces of the light guide plate, and is also capable of allowing heat expansion of the light guide plate.

In addition, having the configuration of including the edge-light illuminating device, the liquid crystal display device and the television receiving device are capable of preventing formation of a gap between the point light sources and the edge faces of the light guide plate in the edge-light illuminating device, and are also capable of allowing heat expansion of the light guide plate in the edge-light illuminating device.

### BRIEF DESCRIPTION OF DRAWINGS

FIG. 1 is an explanatory view showing a schematic configuration of an edge-light illuminating device of one of preferred embodiments of the present invention.

FIG. 2 is an explanatory view showing a schematic configuration of a back face of a light guide plate.

FIG. 3 shows explanatory sectional views showing a schematic configuration of the edge-light illuminating device along the section A-A′ of FIG. 1.

FIG. 4 shows explanatory sectional views showing a schematic configuration of the edge-light illuminating device along the section B-B′ of FIG. 1.

FIG. 5 is an explanatory sectional view showing a schematic configuration of an elastic holding member used in an edge-light illuminating device of another preferred embodiment of the present invention.

FIG. 6 is an explanatory sectional view showing a schematic configuration of an elastic holding member used in an edge-light illuminating device of another preferred embodiment of the present invention.

FIG. 7 is an exploded perspective view showing a liquid crystal display device of one of preferred embodiments of the present invention.

FIG. 8 is an explanatory view showing a layout relation between a liquid crystal panel and an edge-light illuminating device.

FIG. 9 is an explanatory sectional view showing a schematic configuration of the liquid crystal display device along the section C-C′ of FIG. 7.

FIG. 10 is an explanatory sectional view showing a schematic configuration of a liquid crystal display device of another preferred embodiment of the present invention.

FIG. 11 is an exploded perspective view showing a schematic configuration of a television receiving device of one of preferred embodiments of the present invention.

FIG. 12 is an explanatory view showing a schematic configuration of an edge-light illuminating device of another preferred embodiment of the present invention.

### DESCRIPTION OF EMBODIMENTS

Detailed descriptions of an edge-light illuminating device, a liquid crystal display device, and a television receiving device of preferred embodiments of the present invention will now be provided with reference to the accompanying drawings. It is to be noted that the present invention is not limited to the preferred embodiments described in the present specification.

[Edge-Light Illuminating Device]

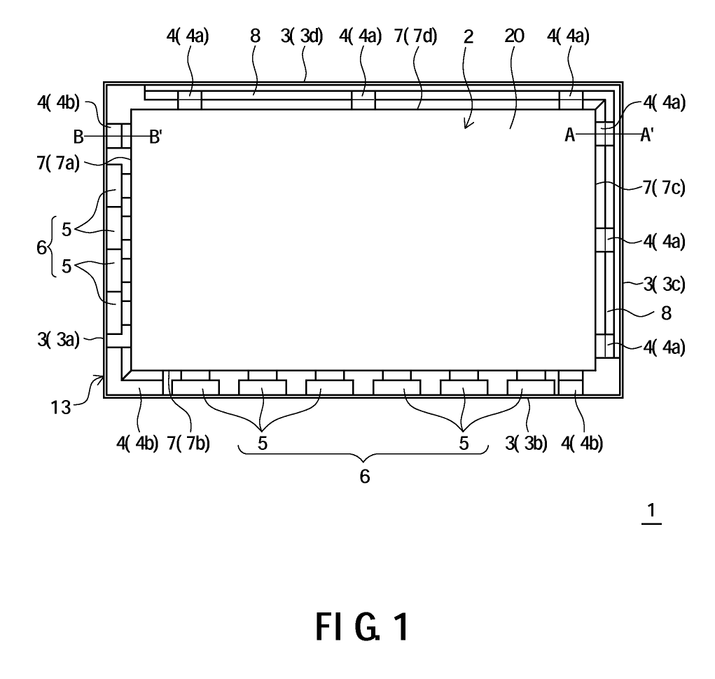

An explanation of an edge-light illuminating device of one of the preferred embodiments of the present invention will be provided with reference to FIGS. 1 to 4. FIG. 1 is an explanatory view showing a schematic configuration of an edge-light illuminating device 1 of the present embodiment of the present invention. The edge-light illuminating device 1 includes a light guide plate 2, a wall 3, holding members 4, and rows 6 each consisting of a plurality of point light sources 5 as shown in FIG. 1. The edge-light illuminating device 1 includes, in addition to the constituent members described above, an optical sheet, a reflection sheet and other constituent members, which are not shown in FIG. 1 for the sake of illustration.

The light guide plate 2 is a transparent plate having a rectangular shape, which is made from an optically-transparent material such as an acrylic resin such as polymethylmethacrylate (PMMA), a polycarbonate (PC) resin, a methyl methacrylate-styrene copolymer (MS resin), and a polystyrene (PS) resin. A material that is generally used for a light guide plate can be used for the light guide plate 2. It is essential only that the light guide plate 2 should have a rectangular shape as a whole. For example, the light guide plate 2 may have the shape of a rectangular transparent plate of which a portion of a corner is cut out. It is to be noted that a “light guide plate having a rectangular shape” includes a light guide plate having a square shape in the present specification.

The light guide plate 2 includes an edge face 7 consisting of edge faces 7a, 7b, 7c and 7d on the four sides of the light guide plate 2. The edge faces 7a and 7c are on the two opposed sides in a shorter direction of the light guide plate 2. The edge faces 7b and 7d are on the two opposed sides in a longer direction of the light guide plate 2.

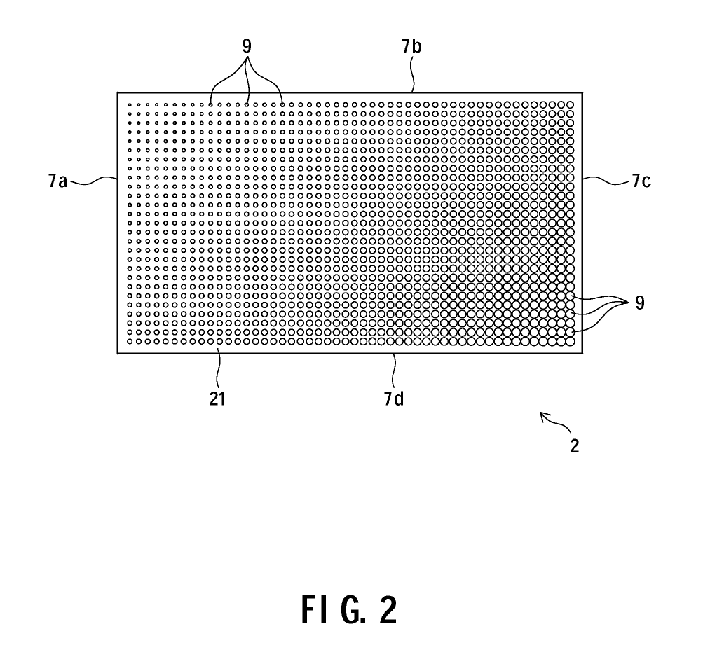

The light guide plate 2 is arranged to repeatedly reflect light, which enters from the edge face 7, between a face on the front of the light guide plate 2 (a front face 20) and a face on the back of the light guide plate 2 (a back face 21), and planarly diffuse the light inside the light guide plate 2. FIG. 2 is an explanatory view showing a schematic configuration of the back face 21 of the light guide plate 2. The light guide plate 2 includes a plurality of scattering members 9 on the back face 21 as shown in FIG. 2, which are arranged to scatter the light from the edge face 7 and emit the light from the front face 20 of the light guide plate 2. The scattering members 9 are preferably provided thereon by dotting paint containing a white pigment in a printing method on the back face 21 of the light guide plate 2, or are preferably provided thereon by forming a plurality of concave portions on the back face 21 of the light guide plate 2.

The wall 3 faces the edge face 7 of the light guide plate 2, and surrounds the light guide plate 2. In the present embodiment of the present invention, the wall 3 defines a side wall that is a portion of a container 13 of low height arranged to house the light guide plate 2 and other constituent members. The container 13 is preferably made from a metallic material or a plastic material as well as a conventional container is. In other embodiments of the present invention, it is not necessary for the wall 3 to define the side wall itself of the container 13 arranged to house the light guide plate 2 and other constituent members. For example, the wall 3 may be a wall that is separately provided more inside within the side wall of the container 13.

The wall 3 of the present embodiment of the present invention forms a rectangular space so as to surround the light guide plate 2 as shown in FIG. 1. The wall 3 includes a wall 3a that faces the edge face 7a of the light guide plate 2, a wall 3b that faces the edge face 7b of the light guide plate 2, a wall 3c that faces the edge face 7c of the light guide plate 2, and a wall 3d that faces the edge face 7d of the light guide plate 2. The light guide plate 2 is disposed in the space formed by the wall 3. The wall 3 has stiffness adequate to maintain its shape (the space).

The holding members 4 are disposed between the edge face 7 of the light guide plate 2 and the wall 3. The holding members 4 are arranged to hold the light guide plate 2 within the space surrounded by the wall 3 and fix the position of the light guide plate 2. The holding members 4 surround the edge face 7 of the light guide plate 2. The holding members 4 are in touch with the wall 3 on their one sides while are in touch with the edge face 7 of the light guide plate 2 on the other sides, so that they can push the edge face 7 of the light guide plate 2, which allows the light guide plate 2 to be kept in the space surrounded by the wall 3.

Two kinds of holding members 4 are used in the present embodiment of the present invention. One of them is elastic holding members 4a that are arranged to push back the edge face 7 of the light guide plate 2 while deformed by an external force (load) that is applied thereto when the elastic holding members 4a get into touch with the edge face 7 of the light guide plate 2. The other is inelastic holding members 4b that are little deformed by an external force (load) that is applied thereto when the inelastic holding members 4b get into touch with the edge face 7 of the light guide plate 2.

The elastic holding members 4a are provided to a frame member 8 having the shape of the letter L that is disposed along wall surfaces of the walls 3c and 3d, and are in touch with the edge faces 7c and 7d of the light guide plate 2, as shown in FIG. 1. The elastic holding members 4a that are in touch with the edge face 7c of the light guide plate 2 push the edge face 7c so as to move the light guide plate 2 toward the wall 3a. The elastic holding members 4a that are in touch with the edge face 7d of the light guide plate 2 push the edge face 7d so as to move the light guide plate 2 toward the wall 3b.

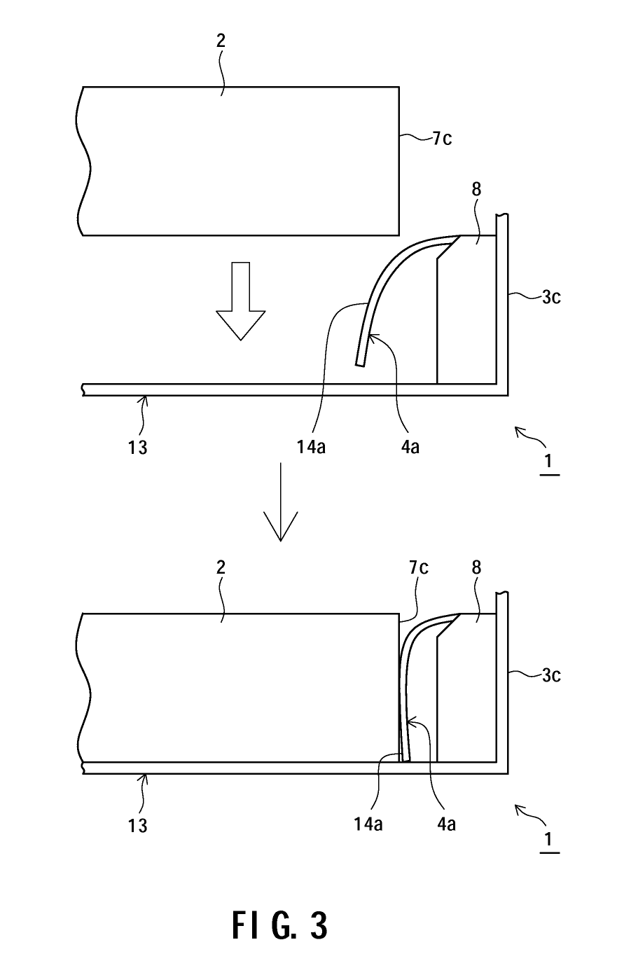

FIG. 3 shows explanatory sectional views showing a schematic configuration of the edge-light illuminating device 1 along the section A-A′ of FIG. 1. The elastic holding members 4a extend from the wall 3 (3c) via the frame member 8 as shown in the upper portion of FIG. 2. The elastic holding members 4a each define plate springs that project from the top edge of the frame member 8. There is a gap between the frame member 8 and the edge face 7c of the light guide plate 2. The frame member 8 has a rectangular shape in cross section, and has its upper corner portion chamfered so as not to interfere with an edge portion of the light guide plate 2. Each of the plate springs defined as the elastic holding members 4a has elasticity, and a shape such as to gradually bend from its root toward its tip. Each of the plate springs includes a surface 14a having a configuration such as to be in touch with the edge face 7c of the light guide plate 2 and push it. Shown in the upper portion of FIG. 3 is the elastic holding member 4a where the elastic holding member 4a is yet to be in touch with the edge face 7c of the light guide plate 2. The elastic holding members 4a and the frame member 8 may be of a monolithic construction, or a separate construction.

Shown in the lower portion of FIG. 3 is a view where the light guide plate 2 is held by the elastic holding member 4a. The elastic holding members 4a have their tips pushed down by the edge portion of the light guide plate 2 on the side of the edge face 7c, and are deformed. The edge portion of the light guide plate 2 is guided downward along the bent shapes of the surfaces 14a of the elastic holding members 4a, which facilitates the light guide plate 2 being housed in the container 13. When the light guide plate 2 is housed in the container 13, the elasticity of the plate springs defined as the elastic holding members 4a acts on the edge face 7c of the light guide plate 2 so as to push it.

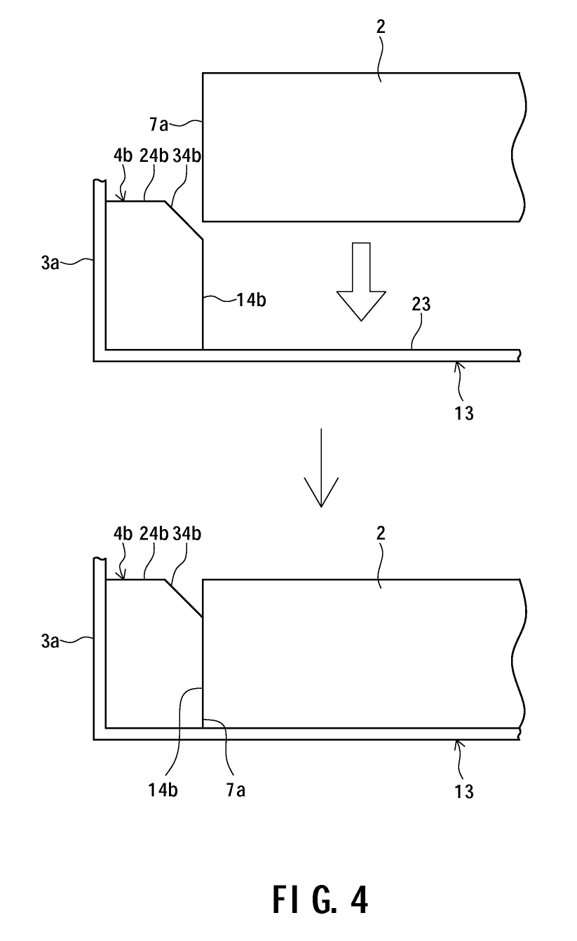

FIG. 4 shows explanatory sectional views showing a schematic configuration of the edge-light illuminating device 1 along the section B-B′ of FIG. 1. Each of the inelastic holding members 4b has a rectangular shape in cross section, and includes a touch face 14b having a configuration such as to be in touch with the edge face 7a of the light guide plate 2 as shown in the upper portion of FIG. 4. The inelastic holding members 4b are made preferably from a plastic material. Each of the inelastic holding members 4b includes a slope face 34b and an upper face (top face) 24b. The slope faces 34b of the inelastic holding members 4b are disposed between the top faces 24b and the touch faces 14b. The slope faces 34b define faces that are formed by chamfering (i.e., C-chamfering) edge portions of the inelastic holding members 4b, and are inclined to a floor face 23 of the container 13. In the present embodiment of the present invention, the touch faces 14b are perpendicular to the floor face 23, and the top faces 24b are horizontal to the floor face 23. The slope faces 34b provided to the inelastic holding members 4b facilitate the edge portions of the light guide plate 2 being guided to the touch faces 14b along the slope faces 34b when the light guide plate 2 is housed in the container 13. Shown in the upper portion of FIG. 4 is the inelastic holding member 4b where the inelastic holding member 4b is yet to be in touch with the edge face 7a of the light guide plate 2.

Shown in the lower portion of FIG. 4 is a view where the edge face 7a of the light guide plate 2 is in touch with the touch faces 14b of the inelastic holding member 4b, and the light guide plate 2 is held by the inelastic holding member 4b. The inelastic holding members 4b do not change their shapes even though they get into touch with the edge face 7a of the light guide plate 2 as shown in FIG. 4. Being interposed between the elastic holding members 4a and the inelastic holding members 4b, the light guide plate 2 has its position fixed.

The inelastic holding members 4b preferably have a configuration such as to be in touch with the one edge face 7 (7a) of the light guide plate 2 as shown in FIG. 1. It is also preferable that the inelastic holding members 4b have a configuration such as to be in touch with both the two edge faces 7 (7a, 7b) of the light guide plate 2.

In housing the light guide plate 2 in the space within the wall 3, the light guide plate 2 is pushed into the space preferably by first bringing the edge faces (7a, 7b) of the light guide plate 2 into touch with the inelastic holding members 4b, and then bringing the edge faces 7 (7c, 7d) of the light guide plate 2 into touch with the elastic holding members 4a.

The inelastic holding members 4b are arranged to hold the light guide plate 2 that pushes the inelastic holding members 4b so as to close the gap between the light guide plate 2 and the point light sources 5 such as LEDs to be described later, and establish an appropriate positional relation with the point light sources 5. In addition, the inelastic holding members 4b can prevent the point light sources 5 and a point light source substrate (e.g., an LED substrate) from being imposed by excessive stress such as to cause damage thereto.

It is preferable that the light guide plate 2 is disposed so as to be held only by the inelastic holding members 4b among the holding members 4 such that no stress is imposed between the point light sources 5 and the light guide plate 2.

The two kinds of holding members 4 consisting of the elastic holding members 4a and the inelastic holding members 4b are preferably made from a white-colored material. The white-colored material defines a high reflective material arranged to diffuse and reflect light and show white color. Examples of the high reflective material include a high reflective polycarbonate. The holding members 4 made from the white-colored material allow the edge-light illuminating device 1 to increase use efficiency of light.

The rows 6 each consisting of the plurality of aligned point light sources 5 are each disposed along the edge face 7a and the edge face 7b of the light guide plate 2 as shown in FIG. 1. The edge face 7a and the edge face 7b of the light guide plate 2 are adjacent to each other. The point light sources 5 are aligned along the two adjacent edge faces 7a and 7b of the light guide plate 2 so as to be in the shape of the letter L in the present embodiment of the present invention.

The row 6 along the edge face 7a and the row 6 along the edge face 7b are disposed between the inelastic holding members 4b as shown in FIG. 1.

The point light sources 5 preferably define light-emitting diodes (LEDs). In each of the rows 6, the point light sources 5 may be aligned leaving no space therebetween, or may be aligned leaving a space therebetween.

It is preferable that the point light sources 5 in the rows 6 are in touch with the edge face 7 of the light guide plate 2 leaving no gap. The configuration of no gap facilitates light from the point light sources 5 entering into the light guide plate 2 from the edge face 7. The light from the point light sources 5 enters from the edge face 7a and the edge face 7b of the light guide plate 2 in the present embodiment of the present invention. The incident light is emitted from the front face 20 of the light guide plate 2.

In the edge-light illuminating device 1 of the present embodiment of the present invention, the row 6 along the edge face 7a of the light guide plate 2 is opposed to the elastic holding members 4a disposed between the edge face 7c and the wall 3c, while interposing the light guide plate 2 therebetween. These elastic holding members 4a are arranged to push the edge face 7c of the light guide plate 2, which acts on the edge face 7a of the light guide plate 2 so as to push the edge face 7a onto the point light sources 5 of the row 6. In a similar manner, the row 6 along the edge face 7b of the light guide plate 2 is opposed to the elastic holding members 4a disposed between the edge face 7d and the wall 3d, while interposing the light guide plate 2 therebetween. These elastic holding members 4a are arranged to push the edge face 7d of the light guide plate 2, which acts on the edge face 7b of the light guide plate 2 so as to push the edge face 7b onto the point light sources 5 of the row 6.

Thus, the edge-light illuminating device 1 of the present embodiment of the present invention has a configuration that the edge faces 7 (7a, 7b) of the light guide plate 2 are pushed onto the point light sources 5 that are aligned in the shape of the letter L, which prevents reduction of the efficiency of the incident light from the light sources 5.

In addition, even when the light guide plate 2 is expanded by heat generated by the point light source rows 6 (the point light sources 5), and the edge face 7d of the light guide plate 2 pushes the elastic holding members 4a on the side of the wall 3d, the elastic holding members 4a can be further deformed to accommodate the expansion of the light guide plate 2. In a similar manner, even when the edge face 7c of the light guide plate 2 pushes the elastic holding members 4a on the side of the wall 3c, the elastic holding members 4a can be further deformed to accommodate the expansion of the light guide plate 2. That is, the edge-light illuminating device 1 of the present embodiment of the present invention has a configuration of allowing heat expansion of the light guide plate 2. It is to be noted that even when the light guide plate 2 is expanded by heat as described above, the edge-light illuminating device 1 of the present embodiment of the present invention has a configuration of allowing the edge faces 7 (7a, 7b) of the light guide plate 2 to be kept in touch with the point light source rows 6.

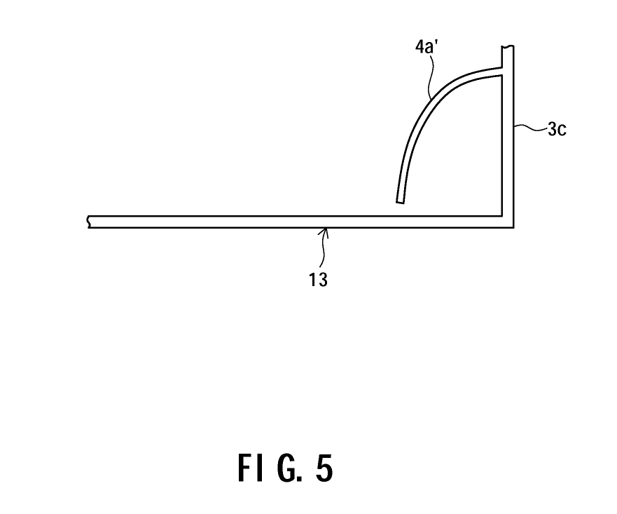

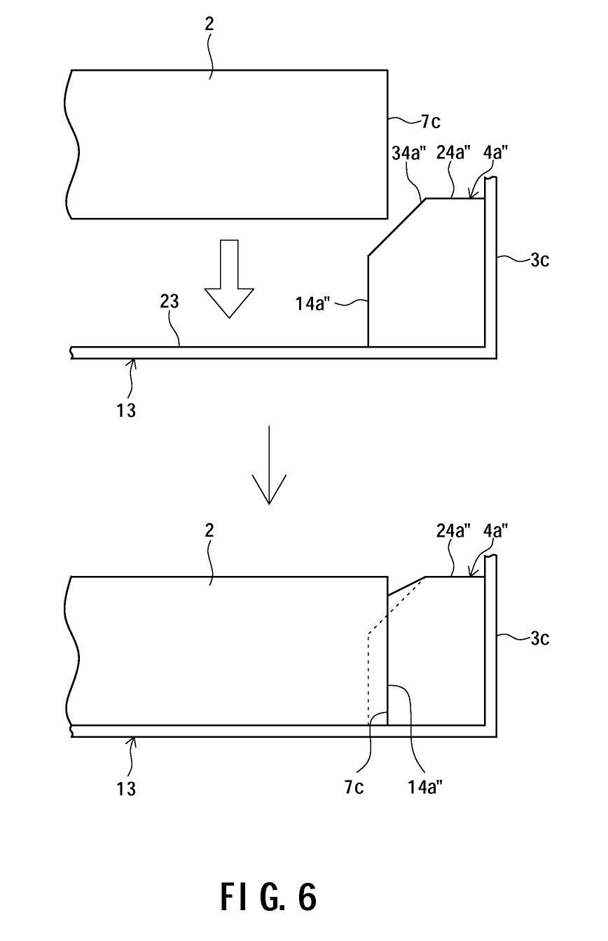

Next, a description of other edge-light illuminating devices of other preferred embodiments of the present invention will be provided with reference to FIGS. 5 and 6. FIG. 5 is an explanatory sectional view showing a schematic configuration of an elastic holding member 4a′ used in the edge-light illuminating device of one of the other preferred embodiments of the present invention. The elastic holding members 4a′ are provided directly to the wall 3 of the container 13 arranged to house the light guide plate 2, and the elastic holding members 4a′ and the wall 3 are of a monolithic construction as shown in FIG. 5. The elastic holding members 4a′ each define plate springs, each of which has a shape such as to gradually bend from its root toward its tip, which is the same as the shape of the elastic holding member shown in FIG. 3.

FIG. 6 is an explanatory sectional view showing a schematic configuration of an elastic holding member 4a″ used in the edge-light illuminating device of another one of the other preferred embodiments of the present invention. The elastic holding members 4a″ each define convex members that have a rectangular shape in cross section and project from the wall 3 (3c) as shown in FIG. 6. The elastic holding members 4a″ shown in FIG. 6 are pushed by the edge face 7c of the light guide plate 2, and their shapes (sizes) are deformed. When surfaces 14a″ of the elastic holding members 4a″ that are in touch with the edge face 7c are moved toward the wall 3c, the elastic holding members 4a″ become small. The elastic holding members 4a″ are preferably made from an elastic material such as rubber. The elastic holding members 4a″ having the configuration described above can be used in the edge-light illuminating device of the present embodiment of the present invention.

Each of the elastic holding members 4a″ includes a slope face 34a″ and an upper face (top face) 24a″. The slope faces 34a″ are disposed between the top faces 24a″ and the touch faces 14a″. The slope faces 34a″ define faces that are formed by chamfering (i.e., C-chamfering) edge portions of the elastic holding members 4a″, and are inclined to the floor face 23 of the container 13. In the present embodiment of the present invention, the touch faces 14a″ are perpendicular to the floor face 23, and the top faces 24a″ are horizontal to the floor face 23. The slope faces 34a″ provided to the elastic holding members 4a″ facilitate the edge portions of the light guide plate 2 being guided to the touch faces 14a″ along the slope faces 34a″ when the light guide plate 2 is housed in the container 13.

It is preferable that the scattering members 9 formed on the back face 21 of the light guide plate 2 are distributed in a manner that the scattering members 9 gradually concentrate from the edge face 7a of the light guide plate 2 on the side along which the point light source row is disposed toward the edge face 7c of the light guide plate 2 on the side along which the elastic holding members are disposed, and also gradually concentrate from the edge face 7b of the light guide plate 2 on the side along which the point light source row is disposed toward the edge face 7d of the light guide plate 2 on the side along which the elastic holding members are disposed. The distribution of the scattering members 9 formed on the back face 21 of the light guide plate 2 as described above facilitates the light that enters from the edge faces 7a and 7b being diffused uniformly inside the light guide plate 2.

The wall 3 is preferably made from a white-colored material, and the holding members 4 are preferably made from a transparent material in other preferred embodiments of the present invention. Examples of the white-colored material include a high reflective polycarbonate. Examples of the transparent material include an acrylic resin such as polymethylmethacrylate (PMMA), a polycarbonate (PC) resin, and a methyl methacrylate-styrene copolymer (MS resin). The wall 3 made from the white-colored material and the holding members 4 made from the transparent material allow the edge-light illuminating device to increase use efficiency of light.

[Liquid Crystal Display Device]

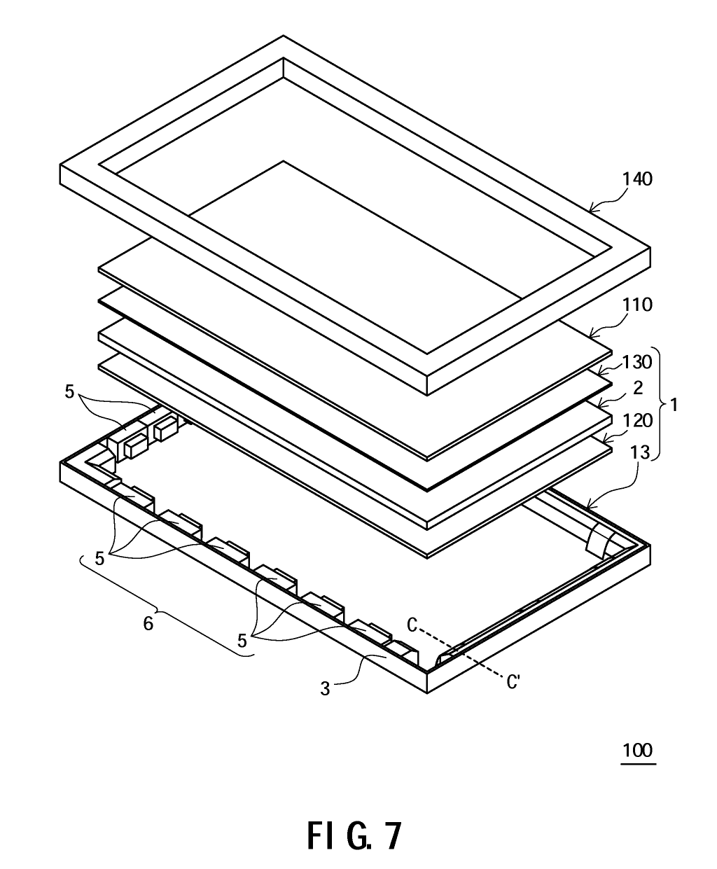

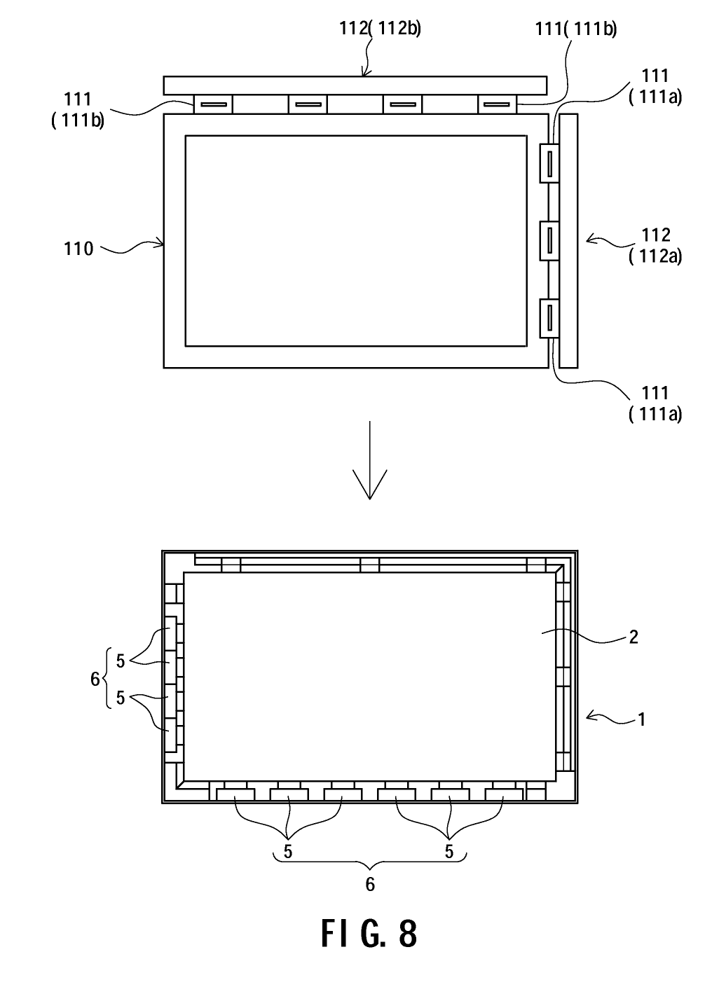

Next, a description of a liquid crystal display device of one of preferred embodiments of the present invention will be provided with reference to FIGS. 7 and 8. FIG. 7 is an exploded perspective view showing a liquid crystal display device 100 of the present embodiment of the present invention. The liquid crystal display device 100 includes the container 13 of low height that includes the point light sources along the wall 3. The container 13 houses a stack of constituent members such as a liquid crystal panel 110 that defines a flat display device while the consistent members are fixed therein. The stack includes a reflection sheet 120, the light guide plate 2 and an optical sheet 130 in this order from the bottom as shown in FIG. 7. A metallic frame 140 is attached to the stack so as to cover it. The liquid crystal display device 100 includes the edge-light illuminating device 1 of the preferred embodiment of the present invention.

A description of a layout relation between the liquid crystal panel 110 and the edge-light illuminating device 1 that are stacked in the liquid crystal display device 100 will be provided with reference to FIG. 8. FIG. 8 is an explanatory view showing the layout relation between the liquid crystal panel 110 and the edge-light illuminating device 1. The liquid crystal panel 110 includes switching elements such as TFTs (Thin Film Transistors) (not shown), bus lines connected to the TFTs (not shown), and terminal members provided to the ends of the bus lines (not shown). The liquid crystal panel 110 includes drivers 111 arranged to provide driving signals to the switching elements, and printed wiring boards (PWBs) 112 connected to the drives 111, which are disposed on one side in a longer direction and one side in a shorter direction of the liquid crystal panel 110. Signals are supplied from the outside to the printed wiring boards 112. The drivers 111 in the shorter direction define gate drives 111a, and the drivers 111 in the longer direction define source drives 111b. The printed wiring board 112 in the shorter direction defines a gate printed wiring board 112a, and the printed wiring board 112 in the longer direction defines a source printed wiring board 112b. The drivers 111 and the printed wiring boards 112 are aligned along the two adjacent sides of the liquid crystal panel 110 having a rectangular shape so as to be in the shape of the letter L.

The liquid crystal panel 110 is stacked on the edge-light illuminating device 1 so that the drivers 111 and the printed wiring boards 112 of the liquid crystal panel 110 may not overlap the point light sources 5 (rows 6) of the edge-light illuminating device 1 that are aligned in the shape of the letter L as shown in FIG. 8. That is, the point light sources 5 of the edge-light illuminating device 1 that are aligned in the shape of the letter L are opposed to the drivers 111 and the printed wiring boards 112 while interposing the light guide plate 2 (or the liquid crystal panel 110) therebetween. The optical sheet 130 is interposed between the liquid crystal panel 110 and the edge-light illuminating device 1 as shown in FIG. 7.

Stacking the liquid crystal panel 110 and the edge-light illuminating device 1 as shown in FIG. 8 allows the point light sources 5 (rows 6) of the edge-light illuminating device 1 to be disposed apart from the drives 111 and the printed wiring boards 112 of the liquid crystal panel 110. The layout of the point light sources 5 and the drivers 111 as described above can prevent electromagnetic waves emitted from the point light sources 5 from causing interference with the drives 111 and the boards 112 and accordingly from causing a noise thereto. The stacking structure of the liquid crystal panel 110 and the edge-light illuminating device 1 produces an effect especially when light-emitting diodes are used as the point light sources 5.

The drives 111 and the printed wiring boards 112 fold so as to envelop the edge portions of the edge-light illuminating device 1. The drivers and the other constituent members are not shown in FIG. 7 for the sake of illustration.

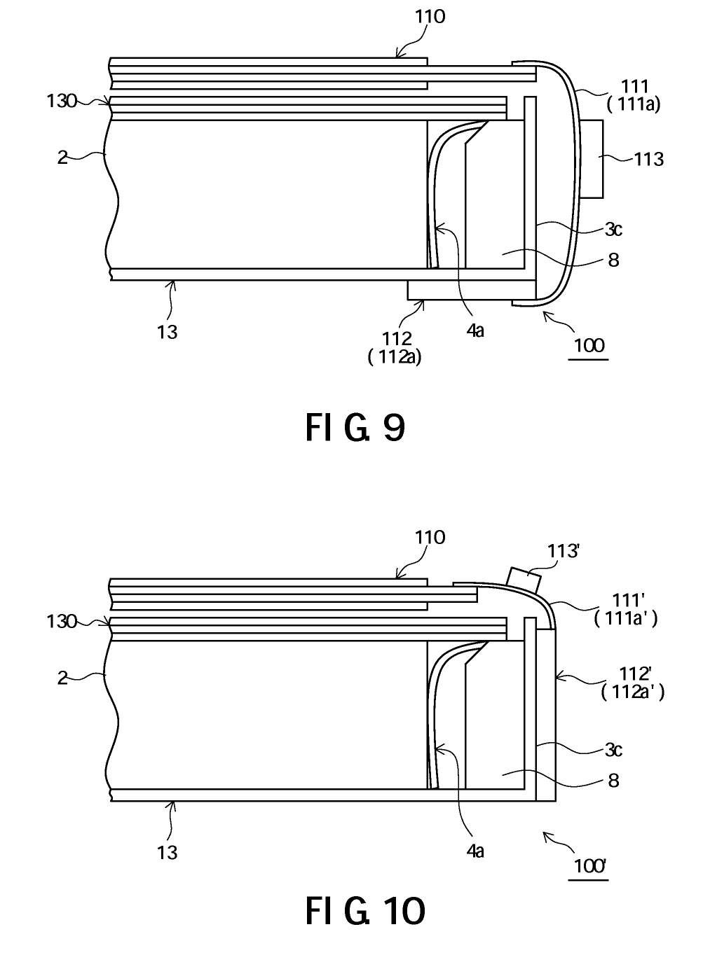

FIG. 9 is an explanatory sectional view showing a schematic configuration of the liquid crystal display device 100 along the section C-C′ of FIG. 7. The optical sheet 130 is stacked on the light guide plate 2 housed in the container 13, and the liquid crystal panel 110 is further stacked on the optical sheet 130 as shown in FIG. 9. The drivers 111a provided on the edge portion of the liquid crystal panel 100 fold so that driver chips 113 provided on the surfaces of the drivers 111a are disposed on the wall 3c of the container 13. The printed wiring board 112 (driver board 112a) connected to edge portions of the drivers 111 (111a) is attached to the bottom of the container 13. The layout of the drivers 111 and the printed wiring boards 112 as described above allows a nondisplay area around a display area of the liquid crystal display 100 to have a narrower width (i.e., allows an attempt to have a narrower frame region to succeed).

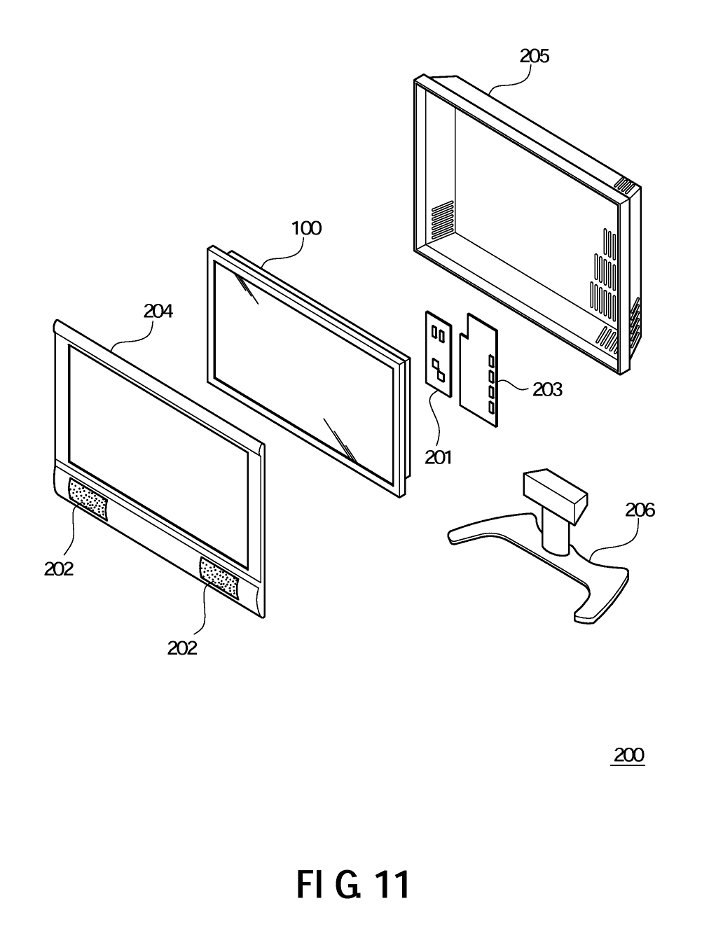

FIG. 10 is an explanatory sectional view showing a schematic configuration of a liquid crystal display device 100′ of another preferred embodiment of the present invention. The basic structure of the liquid crystal display device 100′ shown in FIG. 10 is same as that of the liquid crystal display device 100 shown in FIG. 9. However, a printed wiring board 112a′ that is connected to the edge portion of the liquid crystal panel 110 via drivers 111a′ is disposed on the wall 3c of the container 13 in the liquid crystal display device 100′ shown in FIG. 10. Driver chips 113′ provided on the surfaces of the drivers 111a′ are disposed above the frame member 8 in the container 13. The layout of the drivers 111′ and the printed wiring boards 112′ as described above allows the liquid crystal display 100′ to have a narrower frame region and a thin profile.

The liquid crystal display device 100 of the present embodiment of the present invention is used preferably in a television receiving device, or a variety of liquid crystal display devices other than the television receiving device.

[Television Receiving Device]

A description of a television receiving device of one of preferred embodiments of the present invention will be provided with reference to FIG. 11. FIG. 11 is an exploded perspective view showing a schematic configuration of a television receiving device 200 of the present embodiment of the present invention. The television receiving device 200 includes the liquid crystal display device 100, a tuner 201, loudspeaker units 202, an electric power supply 203, a front side cabinet 204, a back side cabinet 205, and a supporting member 206, as shown in FIG. 11. The television receiving device 200 includes the liquid crystal display device 100 that includes the edge-light illuminating device 1 of the preferred embodiment of the present invention.

The tuner 201 is arranged to produce an image signal and a sound signal of a given channel based on a received radio wave. A conventional terrestrial tuner (analog and/or digital), a BS tuner and a CS tuner are preferably used as the tuner 201.

The loudspeaker units 202 are arranged to produce a sound based on the sound signal produced by the tuner 201. Generally-used speakers are preferably used as the loudspeaker units 202.

The electric power supply 203 is arranged to supply electric power to the liquid crystal display device 100, the tuner 201, the loudspeaker units 202 and other components.

The liquid crystal display device 100, the tuner 201, the loudspeaker units 202 and the electric power supply 203 are housed between the front side cabinet 204 and the back side cabinet 205, which are supported by the supporting member (i.e., stand) 206. Thus, the television receiving device 200 including the supporting member 206 has its edge-light illuminating device 1 (light guide plate 2) in the standing position with respect to the horizontal plane.

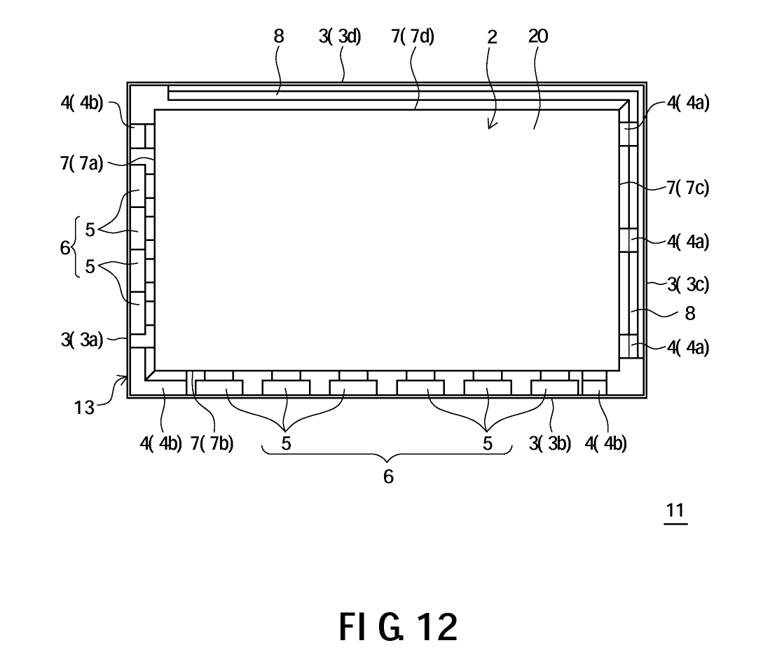

A description of an edge-light illuminating device 11 of another preferred embodiment of the present invention that is preferably used especially in the television receiving device will be provided with reference to FIG. 12. FIG. 12 is an explanatory view showing a schematic configuration of the edge-light illuminating device 11. The configuration of the edge-light illuminating device 11 shown in FIG. 12 is almost same as that of the edge-light illuminating device 1 shown in FIG. 1. Explanations of components of the edge-light illuminating device 11, which are common to the corresponding components of the edge-light illuminating device 1, are omitted, providing reference numerals same as the corresponding components of the edge-light illuminating device 1 to the components of the edge-light illuminating device 11. Having almost the same configurations as described above, the edge-light illuminating device 11 and the edge-light illuminating device 1 are different in that the edge-light illuminating device 11 includes no holding members 4 (elastic holding members 4a) disposed between the edge face 7d of the light guide plate 2 and the wall 3d.

The edge-light illuminating device 11 is used with the edge face 7d of the light guide plate 2 disposed upper and with the edge face 7b of the light guide plate 2 disposed lower. To be specific, the edge-light illuminating device 11 is used while the light guide plate 2 is brought in the standing position with the edge face 7b disposed lower.

To be specific, the edge-light illuminating device 11 is preferably brought in the standing position such that the light guide plate 2 is vertical to the horizontal plane, or such that the light guide plate 2 is inclined to the horizontal plane.

A force to always move toward the wall 3b of the container 13 is applied by gravitation to the light guide plate 2 of the edge-light illuminating device 11. For this reason, the light guide plate 2 gets closer by itself to the point light source row 6 (the point light sources 5) along the edge face 7b without being pushed by the holding members 4 (elastic holding members 4a) shown in FIG. 1. Thus, the use of the edge-light illuminating device 11 in the standing position can prevent formation of a gap between the point light sources 5 and the edge face 7 (7b) of the light guide plate 2 without providing the holding members 4 (elastic holding members 4a) arranged to push the edge face 7b of the light guide plate 2 shown in FIG. 1. In addition, even when the light guide plate 2 is expanded by heat, the use of the edge-light illuminating device 11 allows the expansion of the light guide plate 2 to be accommodated by the gap formed between the edge face 7d on the upper side of the light guide plate 2 and the wall 3d.

The configuration that does not require the holding members 4 (elastic holding members 4a) can reduce the number of components, which can achieve light weight of the edge-light illuminating device 11. In addition, production efficiency of the edge-light illuminating device 11 can be increased.

The edge-light illuminating device 11 is preferably used especially in an oversize liquid crystal display device. For example, the edge-light illuminating device 11 is preferably used in a television receiving device including a liquid crystal display device with 32-inch to 60-inch diagonal screen.

1. An edge-light illuminating device for illuminating a liquid crystal panel from a back side of the panel, the device comprising:
a light guide plate having a rectangular shape;
a wall that surrounds the light guide plate;
a plurality of holding members that are disposed between edge faces of the light guide plate and the wall, and arranged to hold the light guide plate within the wall; and
two rows each consisting of a plurality of point light sources, the two rows each being aligned along the edge faces on two adjacent sides of the light guide plate, wherein some of the holding members, which are opposed to the point light sources while interposing the light guide plate therebetween, comprise elastic holding members having elasticity.

2. The edge-light illuminating device according to claim 1, wherein the elastic holding members are made from an elastic material, and each comprise convex members projecting from the wall.

3. The edge-light illuminating device according to claim 1, wherein the elastic holding members each comprise plate springs that extend from the wall, and the plate springs each comprise tips that are bent and droop down.

4. The edge-light illuminating device according to claim 1, wherein the elastic holding members are made from a white-colored material.

5. The edge-light illuminating device according to claim 1,
wherein the light guide plate comprises a plurality of scattering members distributed on a back face of the light guide plate, the scattering members being arranged to scatter light that enters from the edge faces and emit the light from a front face of the light guide plate,
wherein the scattering members are distributed in a manner that the scattering members gradually concentrate from the sides along which the point light source rows are disposed toward the sides along which the elastic holding members are disposed.

6. The edge-light illuminating device according to claim 1, wherein the point light sources comprise light-emitting diodes.

7. The edge-light illuminating device according to claim 1, wherein the wall is made from a white-colored material, and the holding members are made from a transparent material.

8. The edge-light illuminating device according to claim 1,
wherein the holding members comprise members, each of which has a rectangular shape in cross section and comprises:
a touch face that is in touch with one of the edge faces of the light guide plate;
a top face; and
an edge portion between the touch face and the top face, the edge portion being chamfered.

9. A liquid crystal display device comprising:
a liquid crystal panel; and
the edge-light illuminating device according to claim 1.

10. The liquid crystal display device according to claim 9, wherein the liquid crystal panel comprises drivers disposed at positions corresponding to two adjacent sides of the light guide plate, the two adjacent sides being other than the sides of the light guide plate along which the rows of the point light sources are aligned, the drivers being arranged to provide driving signals to the liquid crystal panel.

11. A television receiving device that comprises the liquid crystal display device according to claim 9.

12. An edge-light illuminating device for illuminating a liquid crystal panel from a back side of the panel, the panel being used in a standing position, the device comprising:
a light guide plate having a rectangular shape;
a wall that surrounds the light guide plate;
a plurality of holding members that are disposed between edge faces of the light guide plate and the wall, and arranged to hold the light guide plate within the wall; and
a light source aligned along one of the edge faces of the light guide plate, wherein the holding members are disposed between the edge faces except the upper edge face and the wall.

13. The edge-light illuminating device according to claim 12, wherein the light source comprises a light-emitting diode.

14. A liquid crystal display device comprising:
a liquid crystal panel; and
the edge-light illuminating device according to claim 12.

15. A television receiving device that comprises the liquid crystal display device according to claim 14.
